(19) United States
(12) Patent Application Publication
(10) Pub. No.: US 2017/0116730 A1
(43) Pub. Date: Apr. 27, 2017

(54) MEDICAL IMAGE PROCESSING DEVICE AND PROGRAM

(71) Applicant: KONICA MINOLTA, INC., Tokyo (JP)

(72) Inventor: Kenji YAMANAKA, Tokyo (JP)

(73) Assignee: KONICA MINOLTA, INC., Tokyo (JP)

(21) Appl. No.: 15/270,859

(22) Filed: Sep. 20, 2016

(30) Foreign Application Priority Data
Oct. 26, 2015 (JP) 2015-209456

(51) Int. Cl. G06T 7/00

(52) U.S. Cl. CPC G06T 7/0012; G06T 2207/20224

(57) ABSTRACT

A medical image processing device includes: a difference image generation unit configured to multiply signal values of corresponding pixels of a plurality of radiation images by a predetermined weight coefficient and perform a difference process to generate a difference image, the plurality of radiation images being obtained in such a manner that the same object is irradiated with beams of radiation having different energy distributions at different timings; and a setting unit configured to set different weight coefficients for a specific region of the radiation image and a region other than the specific region, wherein the difference image generation unit generates the difference image using the weight coefficients set by the setting unit.

The entire disclosure of Japanese Patent Application No. 2015-209456 filed on Oct. 26, 2015 including description, claims, drawings, and abstract are incorporated herein by reference in its entirety.

### BACKGROUND OF THE INVENTION

Field of the Invention

The present invention relates to a medical image processing device and a program.

Description of the Related Art

A so-called energy subtraction process is conventionally known. Specifically, making use of the fact that an attenuation amount of radiation that has passed through an object varies in accordance with a substance constituting the object, a plurality of radiation images (a high energy image and a low energy image) is obtained in such a manner that the object is irradiated with beams of radiation having different energy distributions, and a difference image is obtained in such a manner that signal values of corresponding pixels of the plurality of radiation images are multiplied by an appropriate weight coefficient and subjected to a difference process. A radiation image in which only a specific structure is extracted can be obtained by the energy subtraction process. For example, by generating such a soft tissue image (soft part image) that a bone part is removed from a breast image, it is possible to observe a shadow that appears in the soft part without being hindered by the bone. In addition, by generating a bone part image from which the soft part is removed, it is possible to observe a shadow that appears in the bone part without being hindered by the soft part.

The weight coefficient that is used for the energy subtraction process can be optimally determined on the basis of a linear attenuation coefficient of a structure with respect to an average energy of beams of radiation (average value of energy distributions of the beams of radiation) that are radiated when the high energy image is generated, and on the basis of a linear attenuation coefficient of a structure with respect to an average energy of beams of radiation that are radiated when the low energy image is generated. The linear attenuation coefficient is an index value indicating a ratio of radiation attenuated when the radiation passes through the subject. Each substance has the linear attenuation coefficient that depends on the radiation energy (refer to FIG. 12).

In a case where photographing is performed using continuous spectrum radiation, a phenomenon called beam hardening occurs. Specifically, when the radiation passes through the substance, the radiation having a low energy is absorbed more than the radiation having a high energy, and the energy distribution of the radiation moves upward as the radiation passes through the object. When the energy distribution of the radiation is changed due to the influence of the beam hardening, the linear attenuation coefficient also changes as illustrated in FIG. 12. Therefore, in a case where the weight coefficient that is used for the energy subtraction process is a fixed value, the weight coefficient might not be the most suitable weight coefficient, and a portion of a structure to be removed might remain in a region that is largely affected by the beam hardening such as an area where structures overlap each other and a place where a thick structure exists.

In this regard, for example, JP 2002-152593 A describes a technique for setting a weight coefficient for each pixel based on a difference between logarithmic values of radiation amounts in respective pixels of photographed two radiation images, or on a logarithmic value of a ratio of the radiation amounts.

JP 2010-194261 A and JP 2013-85967 A describe a weight coefficient for an entire image that is changed by operation for a slide bar.

A change of a radiation energy distribution caused by beam hardening varies in accordance with a substance through which radiation passes or a distance by which the radiation passes through the substance. A human body includes a plurality of substances overlapping each other in a complicated manner. Therefore, a structure to be removed might not be removed with a fair degree of accuracy by a method of regularly setting a weight coefficient for the entire image in accordance with a difference between logarithmic values of radiation amounts in respective pixels or a logarithmic value of a ratio of the radiation amounts as described in JP 2002-152593 A. In a configuration described in JP 2010-194261 A and JP 2013-85967 A for setting a single weight coefficient for the entire image, even if a remaining structure can be removed by an adjustment of the weight coefficient, other problems occur, that is, an unnecessary structure appears on the other part, or a necessary structure becomes invisible.

### SUMMARY OF THE INVENTION

An object of the present invention is to improve quality of an entire image of a difference image generated in an energy subtraction process.

To achieve the abovementioned object, according to an aspect, a medical image processing device reflecting one aspect of the present invention comprises:
a difference image generation unit configured to multiply signal values of corresponding pixels of a plurality of radiation images by a predetermined weight coefficient and perform a difference process to generate a difference image, the plurality of radiation images being obtained in such a manner that the same object is irradiated with beams of radiation having different energy distributions at different timings; and
a setting unit configured to set different weight coefficients for a specific region of the radiation image and a region other than the specific region, wherein
the difference image generation unit generates the difference image using the weight coefficients set by the setting unit.

According to an invention of Item. 2, in the invention of Item. 1,
the medical image processing device preferably comprises a designating unit configured to designate the specific region based on a difference image generated in such a manner that signal values of all pixels of the radiation image are multiplied by a single weight coefficient and subjected to the difference process by the difference image generation unit.

According to an invention of Item. 3, in the invention of Item. 2,
the medical image processing device preferably comprises a display unit configured to display the difference image generated in such a manner that the signal values of all the pixels of the radiation image are multiplied by the single weight coefficient and subjected to the difference process by the difference image generation unit, and
the designating unit preferably designates, as the specific region, a region designated by user operation from the difference image displayed by the display unit.

According to an invention of Item. 4, in the invention of Item. 2,
the designating unit preferably designates the specific region by analyzing a signal value of the difference image generated in such a manner that the signal values of all the pixels of the radiation image are multiplied by the single weight coefficient and subjected to the difference process by the difference image generation unit.

According to an invention of Item. 5, in the invention of Item. 4,
the designating unit preferably recognizes a region in which a deterioration in image quality caused by an influence of beam hardening occurs in the difference image by analyzing the difference image generated in such a manner that the signal values of all the pixels of the radiation image are multiplied by the single weight coefficient and subjected to the difference process by the difference image generation unit, and
the designating unit preferably designates the specific region based on the recognized region.

According to an invention of Item. 6, in the invention of Item. 2, 4, or 5,
the designating unit preferably designates the specific region based on information of a region in which a deterioration in image quality caused by an influence of beam hardening has occurred in a previously generated difference image.

According to an invention of Item. 7, in the invention of Item. 2, 4, or 5,
the designating unit preferably designates the specific region based on information indicating a region in which a deterioration in image quality that is caused by an influence of beam hardening is likely to occur.

According to an invention of Item. 8, in the invention of any one of Items. 1 to 7,
the setting unit preferably sets the different weight coefficients for the specific region and the region other than the specific region in accordance with user operation.

According to an invention of Item. 9, in the invention of any one of Items. 1 to 7,
the setting unit preferably analyzes each of the specific region and the region other than the specific region in the difference image generated in such a manner that signal values of all pixels of the radiation image are multiplied by a single weight coefficient and subjected to the difference process by the difference image generation unit, and
the setting unit preferably sets the different weight coefficients for the specific region and the region other than the specific region based on an analysis result.

According to an invention of Item. 10, in the invention of Item. 9,
the medical image processing device preferably comprises an adjustment unit configured to adjust the weight coefficient set by the setting unit.

To achieve the abovementioned object, according to an aspect, a non-transitory recording medium storing a computer readable program reflecting one aspect of the present invention causes a computer to function as:
a setting unit configured to set different weight coefficients for a specific region and a region other than the specific region in a plurality of radiation images obtained in such a manner that the same object is irradiated with beams of radiation having different energy distributions at different timings; and
a difference image generation unit configured to multiply signal values of corresponding pixels of the plurality of radiation images by the set weight coefficients and perform a difference process to generate a difference image.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating an overall configuration of a radiation image system according to an embodiment;

FIG. 2 is a block diagram illustrating a functional configuration of a medical image processing device in FIG. 1;

FIG. 3 is a flowchart illustrating a difference image generation process A that is executed by a control unit in FIG. 2 in a first embodiment;

FIG. 4 is a diagram illustrating an exemplary soft part image and an exemplary bone part image;

FIG. 5A is a diagram illustrating a position P1 of a profile of an inner lung field in a region R of each of the bone part image and the soft part image illustrated in FIG. 4;

FIG. 5B is a diagram illustrating a position P2 of a profile of an outer lung field in the region R of each of the bone part image and the soft part image illustrated in FIG. 4;

FIG. 6A is a diagram illustrating the profile at the position P1 in each of the bone part image and the soft part image;

FIG. 6B is a diagram illustrating the profile at the position P2 in each of the bone part image and the soft part image;

FIG. 7 is a diagram illustrating a straight line representing a relation between a signal value of a pixel (or a signal value difference between pixels) and a weight coefficient;

FIG. 8 is a diagram illustrating a curve representing a relation between a signal value of a pixel (or a signal value difference between pixels) and a weight coefficient;

FIG. 9 is a diagram illustrating a signal value profile before and after a process for aligning a baseline of a signal value of a designated region with a region outside the designated region;

FIG. 10 is a flowchart illustrating a difference image generation process B that is executed by the control unit in FIG. 2 in a second embodiment;

FIG. 11 is a flowchart illustrating a difference image generation process C that is executed by the control unit in FIG. 2 in a third embodiment; and

FIG. 12 is a diagram illustrating a relation between a radiation energy and a linear attenuation coefficient of each of a bone and a soft tissue.

### DESCRIPTION OF THE PREFERRED EMBODIMENTS

Hereinafter, an embodiment of the present invention will be described with reference to the drawings. However, the scope of the invention is not limited to the illustrated examples.

### First Embodiment

### [Configuration of Radiation Image System 100]

First, a configuration of a first embodiment will be described.

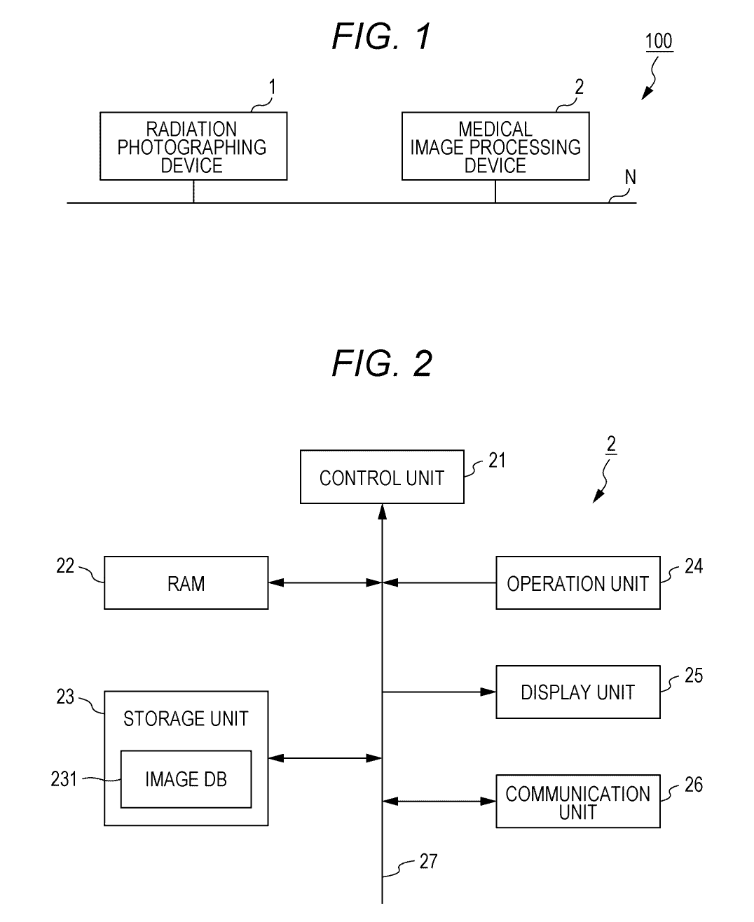

A radiation image system 100 according to the first embodiment is illustrated in FIG. 1. The radiation image system 100 includes a radiation photographing device 1 and a medical image processing device 2. For example, the radiation photographing device 1 and the medical image processing device 2 are connected by a communication network N such as a local area network (LAN) so as to be able to send and receive data.

The radiation photographing device 1 includes, for example, a flat panel detector (FPD) device and a computed radiography (CR) device. The radiation photographing device 1 has a radiation source and a radiation detector (FPD and CR cassette), and irradiates an object arranged between the radiation source and the radiation detector with radiation. The radiation photographing device 1 then detects the radiation that has passed through the object to generate a digital radiation image, and outputs the digital radiation image to the medical image processing device 2.

In the present embodiment, the radiation photographing device 1 irradiates the object with beams of radiation having different energy distributions at different timings to obtain a plurality of radiation images. The radiation photographing device 1 then outputs the plurality of radiation images to the medical image processing device 2. More specifically, an X-ray tube voltage (hereinafter referred to as a tube voltage) is changed (for example, a high tube voltage of 100 to 140 kVp and a low tube voltage of 50 to 80 kVp), and the object is irradiated with beams of radiation twice, whereby two radiation images including a high energy image and a low energy image are obtained. The more radiation the object transmits, the greater a signal value of each pixel of the radiation image obtained in the radiation photographing device 1 is. The greater the signal value is, the more blackly the signal value is drawn on the radiation image.

An examination ID, patient information, a photographed site, a photographing condition (tube voltage information or the like), and a photographing date or the like are associated with the radiation image and output to the medical image processing device 2.

The medical image processing device 2 is a device that performs a difference process (performs an energy subtraction process) using the high energy image and the low energy image input from the radiation photographing device 1, thereby generating a difference image (a soft part image and a bone part image).

The medical image processing device 2 includes, as illustrated in FIG. 2, a control unit 21, a RAM 22, a storage unit 23, an operation unit 24, a display unit 25, and a communication unit 26 or the like. The respective components are coupled by a bus 27.

The control unit 21 includes a central processing unit (CPU) or the like. The control unit 21 reads various programs such as a system program and a processing program stored in the storage unit 23 and expands the programs to the RAM 22. The control unit 21 then executes various processes including a difference image generation process A which will be described later in accordance with the expanded programs. The control unit 21 thus functions as a setting unit, a difference image generation unit, and a designating unit.

The RAM 22 forms a work area in the various processes that are executed and controlled by the control unit 21. The work area temporarily stores the various programs that are read from the storage unit 23 and executable in the control unit 21, input or output data, and parameters or the like.

The storage unit 23 includes a hard disk drive (HDD), a semiconductor non-volatile memory or the like. As described above, the various programs and the data required for the execution of the programs are stored in the storage unit 23. The storage unit 23 is provided with an image DB 231 that stores, for example, the radiation image sent from the radiation photographing device 1 and the difference image generated in the medical image processing device 2 in association with the patient information, the photographed site, and the date or the like.

The operation unit 24 includes a keyboard and a pointing device such as a mouse. The keyboard includes a cursor key, a number input key, and various function keys or the like. The operation unit 24 outputs, as an input signal to the control unit 21, a depression signal from a key subjected to depression operation in the keyboard and an operation signal from the mouse. The operation unit 24 also includes a touch panel. The touch panel detects depression operation on a screen of the display unit 25 performed by a tablet pen or a finger, and outputs, to the control unit 21, positional information of a position at which the depression operation is performed.

The display unit 25 includes a monitor such as, for example, a cathode ray tube (CRT) and a liquid crystal display (LCD). The display unit 25 displays various screens in accordance with an instruction of a display signal input from the control unit 21.

The communication unit 26 includes a network interface or the like. The communication unit 26 sends and receives data to and from an external device connected to the communication network N via a switching hub.

[Operation of Radiation Image System 100]

Next, operation of the radiation image system 100 will be described.

First, the object is photographed in the radiation photographing device 1. At this time, positions of the radiation source and the radiation detector are adjusted so that the radiation source and the radiation detector face each other. An object site is positioned between the radiation source and the radiation detector. The object site is irradiated with beams of radiation having different tube voltages at different timings, and photographed twice. The high energy image and the low energy image obtained by the photographing are associated with supplementary information such as the examination ID, the patient information, the photographed site (object site), the photographing condition (tube voltage or the like), and the photographing date or the like. The high energy image and the low energy image are then sent to the medical image processing device 2 via the communication network N.

In the medical image processing device 2, when the high energy image and the low energy image from the radiation photographing device 1 are received by the communication unit 26, the difference image generation process A is executed by the control unit 21.

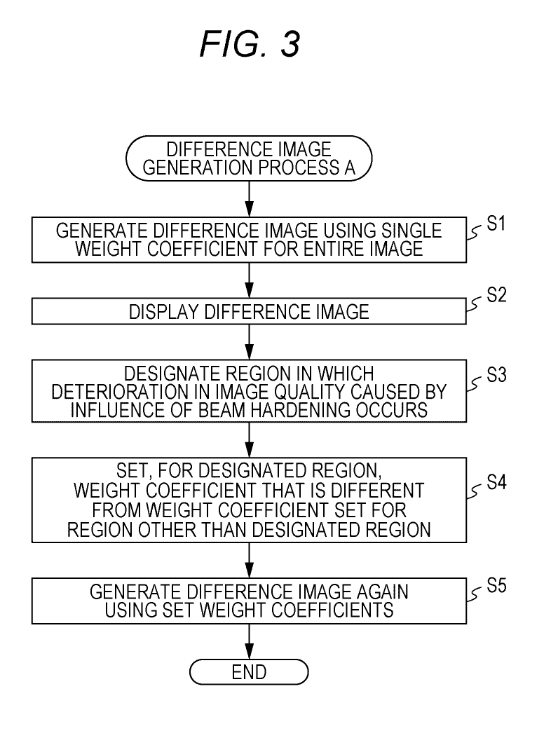

A flowchart of the difference image generation process A that is executed by the control unit 21 is illustrated in FIG. 3. The control unit 21 and the program stored in the storage unit 23 cooperate with each other, whereby the difference image generation process A is executed.

First, the control unit 21 generates a difference image using a single weight coefficient for the entire image (step S1).

As indicated in (Formula 1), it is possible to generate the difference image by multiplying, by the weight coefficient, signal values of corresponding pixels of the two radiation images, i.e., the high energy image and the low energy image, and obtaining a difference. In (Formula 1), P is a signal value of a pixel (x, y) of the difference image, α is a weight coefficient, H is a signal value of a pixel (x, y) of the high energy image, and L is a signal value of a pixel (x, y) of the low energy image. The corresponding pixels are also referred to as pixels of the two images having the same coordinate information.

P=α*H−L (Formula 1)

Consequently, the difference image representing a specific structure (from which other structures are removed) can be generated. When the value of the weight coefficient is changed, the structure represented in the difference image and the structure removed from the difference image can also be changed. For example, in a case where the radiation image is a breast image, by changing the weight coefficient α, it is possible to generate a soft part image representing a soft part of the object from which bones are removed and a bone part image representing a bone part of the object from which the soft part is removed. The weight coefficient that is used in step S1 is common to all the pixels, and the most suitable weight coefficient that depends on the structure represented in (removed from) the difference image is set as a default value in advance.

In (Formula 1), the signal value of the pixel (x, y) of the high energy image, i.e., H, is weighted. Alternatively, the signal value of the pixel (x, y) of the low energy image, i.e., L, may be weighted, and both H and L may be weighted.

Next, the control unit 21 causes the display unit 25 to display the generated difference image (step S2). Consequently, a user can confirm whether the difference image representing the specific structure from which the structure to be removed is removed is generated.

Next, the control unit 21 designates a region of the difference image in which a deterioration in image quality caused by an influence of beam hardening occurs (step S3).

In a case where the difference process is performed using the default weight coefficient, the weight coefficient is not appropriate in the region strongly affected by the beam hardening. As a result, the structure to be removed might not be completely removed and thus remain, or the specific structure to be diagnosed might become difficult to see. In step S2, therefore, the region in which the deterioration in the image quality caused by the influence of the beam hardening occurs is designated as a specific region for which the weight coefficient is to be corrected.

The region for which the weight coefficient is to be corrected may be (manually) designated by operation for the operation unit 24 by the user (user operation), or may be automatically designated by the control unit 21 by means of an image analysis. The manual designation and the automatic designation may be combined.

With regard to a method for designating the region for which the weight coefficient is to be corrected in accordance with the user operation, for example, the region for correction on the difference image displayed on the display unit 25 can be surrounded freehand by the user using the operation unit 24 (the mouse or the tablet pen), a finger or the like. In this case, since the designation might be ambiguously performed, the control unit 21 may automatically align a line drawn on the difference image with an edge line located closest to the line. As a method for automatically aligning the drawn line with the edge line, for example, an intelligent scissors computer tool or the like described in “Intelligent Scissors for Image Composition”, Computer Graphics Proceedings, Annual Conference Series, 1995 can be used.

Alternatively, for example, the region for which the weight coefficient is to be corrected may be designated in such a manner that a region designating template having a rectangular shape or the like is displayed on the difference image displayed on the display unit 25, and the user moves the template by means of the operation unit 24. The user can preferably adjust the vertical width, the horizontal width, and the rotation of the template by means of the operation unit 24.

With regard to a method for designating the region for which the weight coefficient is to be corrected by means of the image analysis, for example, a binarization process, an edge detection process or the like is performed on the difference image, whereby the region in which the deterioration in the image quality caused by the influence of the beam hardening occurs (for example, a region in which the structure to be removed is not completely removed and thus remains) is automatically recognized, and the recognized region is designated as the region for which the weight coefficient is to be corrected (first method).

For example, in the soft part image, i.e., the difference image generated from the breast radiation image, a region in which the bone part remains is automatically recognized, and the recognized region is designated as the region for which the weight coefficient is to be corrected. More specifically, a bone region is detected in the bone part image by means of the binarization process, and a profile of a signal value at a position in the soft part image corresponding to a boundary of the bone region detected in the bone part image is produced. When edge information exceeding a threshold value defined in advance on the profile (a signal difference between adjacent pixels on the profile) exists, a region surrounded by the edge is recognized as the bone region in which the bone part remains.

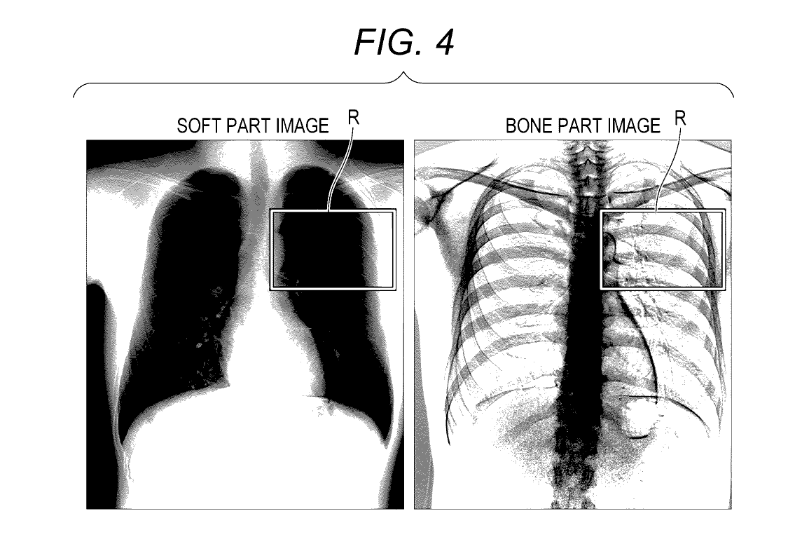

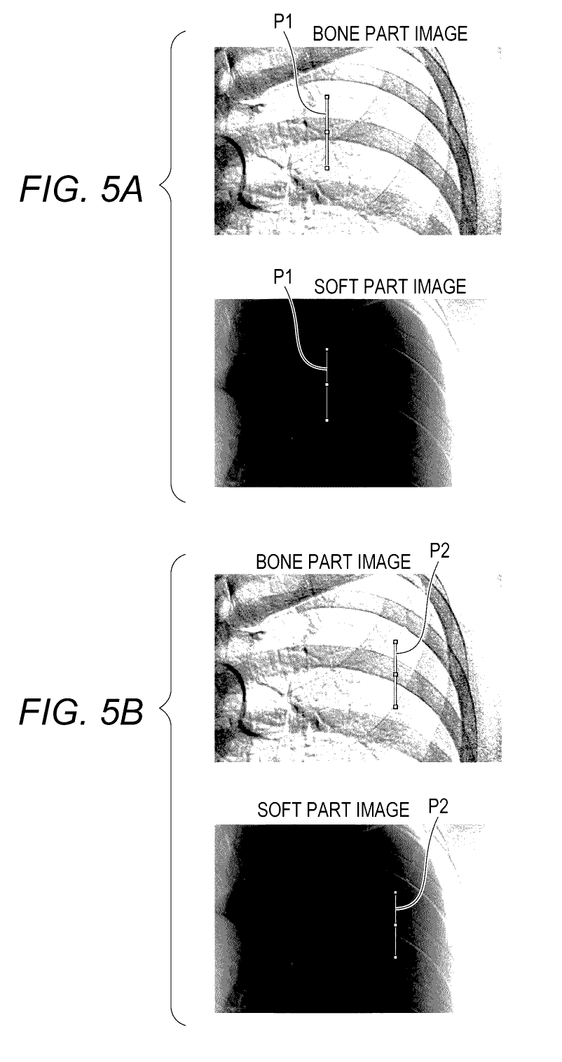

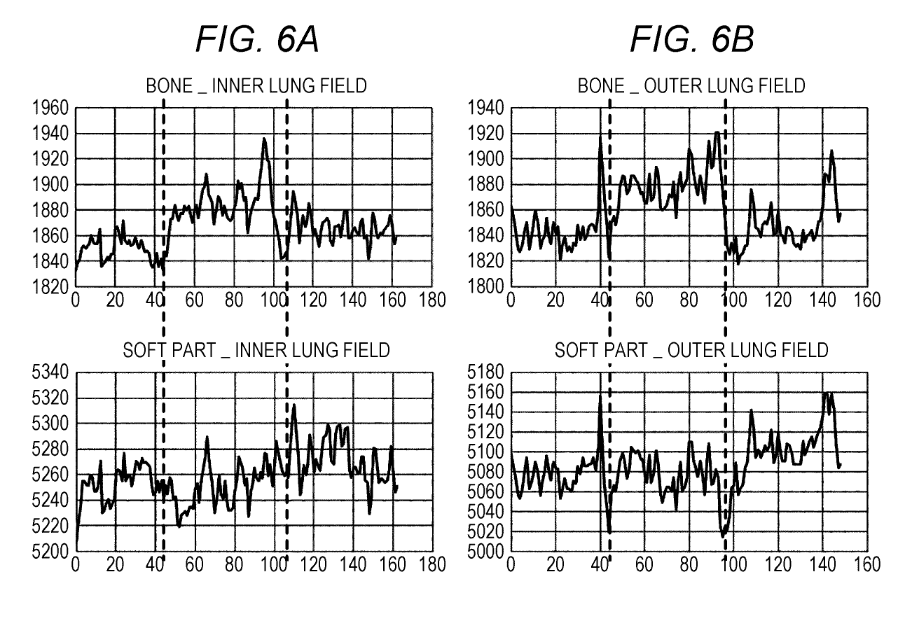

An exemplary soft part image and an exemplary bone part image are illustrated in FIG. 4. A position P1 of a profile of an inner lung field in a region R of each of the bone part image and the soft part image in FIG. 4 is illustrated in FIG. 5A. A position P2 of a profile of an outer lung field in the region R of each of the bone part image and the soft part image in FIG. 4 is illustrated in FIG. 5B. The profile at the position P1 in the bone part image is illustrated in an upper row of FIG. 6A, and the profile at the position P1 in the soft part image is illustrated in a lower row of FIG. 6A. The profile at the position P2 in the bone part image is illustrated in an upper row of FIG. 6B, and the profile at the position P2 in the soft part image is illustrated in a lower row of FIG. 6B.

As illustrated in FIGS. 6A and 6B, in the bone part images illustrated in FIGS. 5A and 5B, large signal changes are observed in boundaries of the bones (positions represented by broken lines) both in the inner lung field and in the outer lung field. In the soft part images, however, a large signal change is not observed in a boundary of the bone in the inner lung field, and a large signal change is observed in a boundary of the bone only in the outer lung field. The signal change in the outer lung field in the soft part image is detected as the edge of the bone part, and the region surrounded by the edge is recognized as the region in which the deterioration in the image quality caused by the influence of the beam hardening occurs.

A region in which the deterioration in the image quality that is caused by the influence of the beam hardening is likely to occur is a region that absorbs much radiation. In a radiation image of a human body, the region in which the deterioration in the image quality that is caused by the influence of the beam hardening is likely to occur is a region in which structures that absorb much radiation (for example, bones or the like) overlap each other, or a region in which a thick structure that absorbs much radiation exists. Therefore, information of the region in which the deterioration in the image quality that is caused by the influence of the beam hardening is likely to occur in the human body can be obtained from previous data experimentally and empirically. For example, in a radiation image of a front breast part, the region in which the deterioration in the image quality that is caused by the influence of the beam hardening is likely to occur is a side edge part of an outer lung field, a clavicle, and a vertebral body or the like.

In this regard, for each object site, positional information of the region in which the deterioration in the image quality that is caused by the influence of the beam hardening is likely to occur obtained from the previous data experimentally and empirically (in the front breast image, a periphery of a contour of the outer lung field, the clavicle, and the vertebral body or the like) may be stored in the storage unit 23, the positional information may be obtained from the storage unit 23 in step S3, the region may be recognized in the currently generated difference image (or the high energy image) or the like, and the recognized region may be designated as the region for which the weight coefficient is to be corrected (second method).

Alternatively, positional information of a region designated as a region in which the deterioration in the image quality caused by the influence of the beam hardening has occurred in a previous difference image of the same site of the same patient may be stored in the storage unit 23, the previous difference image and the current difference image generated in step S1 may be aligned in step S3, and a region of the current difference image corresponding to the region of the previous difference image in which the deterioration in the image quality caused by the influence of the beam hardening has occurred may be designated as the region for which the weight coefficient is to be corrected (third method).

When the region recognized in the above-mentioned first method is included in the region recognized in the second or third method, the region may be recognized as the region in which the deterioration in the image quality caused by the influence of the beam hardening has occurred. As a result, accuracy of the automatic recognition can be improved.

In addition, the region automatically recognized on the difference image may be surrounded and displayed on the display unit 25, the user may finely adjust the displayed surrounded region by means of the operation unit 24, and the adjusted region may be designated as the region for correction.

When the region in which the deterioration in the image quality caused by the influence of the beam hardening occurs is designated, the control unit 21 newly sets, for the designated region of the radiation image, a weight coefficient that is different from the default weight coefficient set for a region other than the designated region (step S4). The control unit 21 generates a difference image again using the set weight coefficient (step S5).

In step S4, the weight coefficient may be newly set for the entire designated region. Alternatively, a specific structure region within the designated region may be extracted, and the weight coefficient may be newly set for the extracted structure region serving as the designated region. For example, when the designation is roughly performed in step S3, that is, for example, when the region is designated by the user operation, it is preferable that the specific structure region within the designated region is extracted, and the weight coefficient is newly set for the extracted structure region serving as the designated region. This is because there is a possibility of an adverse effect if the weight coefficient for a region that is hardly affected by the beam hardening is corrected. An example of the adverse effect includes an unnecessary structure that undesirably emerges due to the correction.

The setting of the weight coefficient in step S4 is performed on the basis of adjustment operation by the user for the weight coefficient.

For example, the control unit 21 displays, on the display unit 25 together with the difference image, a graphical user interface (GUI) such as a slide bar and an operation button serving as an adjustment unit for adjusting the weight coefficient. The control unit 21 then sets the weight coefficient that is uniform within the designated region in accordance with operation by the user for the GUI such as the slide bar and the operation button by means of the operation unit 24. Alternatively, the weight coefficient that is uniform within the designated region may be set in accordance with, for example, wheel operation for the mouse of the operation unit 24 or input of the weight coefficient by means of a numeric keypad. The control unit 21 then multiplies a signal value of the designated region of the radiation image by the weight coefficient set in step S4, and multiplies a signal value of the outside of the designated region by the default weight coefficient. The control unit 21 thus generates the difference image using the above-mentioned (Formula 1) and displays the difference image on the display unit 25. In a case where a plurality of regions is designated, the weight coefficient can be adjusted for each of the designated regions. Consequently, the most suitable weight coefficient can be set for each region.

Alternatively, instead of setting the weight coefficient that is uniform within the designated region, it is possible to set the weight coefficient so that the weight coefficient is linearly or non-linearly changed in accordance with the signal value of the pixel within the designated region or a signal value difference between the pixels within the designated region (a difference between the signal value of the high energy image and the signal value of the low energy image).

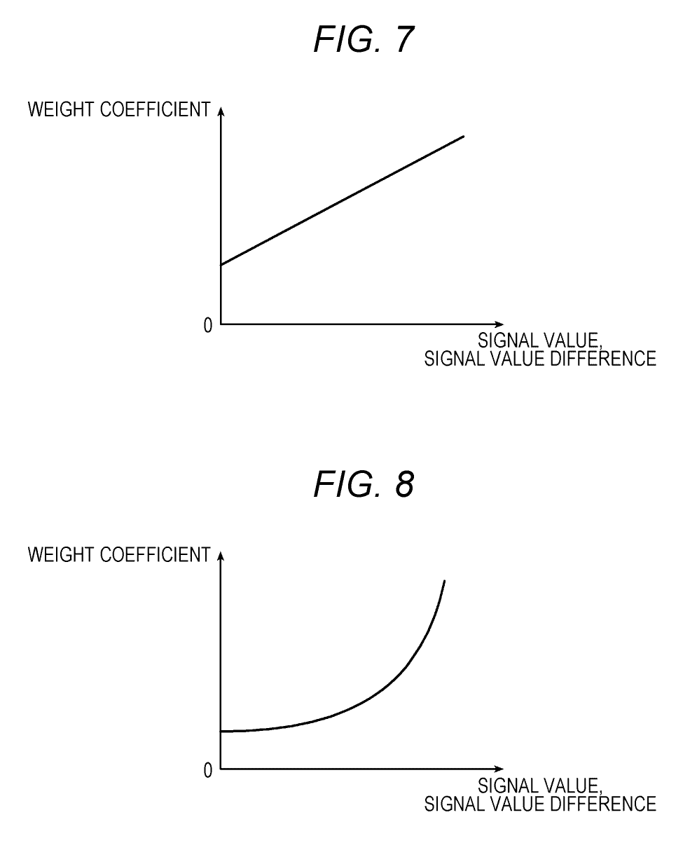

In a case where the weight coefficient within the designated region is linearly changed, for example, the control unit 21 displays, on the display unit 25, a straight line representing a relation between the signal value of the pixel (or the signal value difference between the pixels) and the weight coefficient as illustrated in FIG. 7. The control unit 21 then adjusts the weight coefficient for each pixel within the designated region in accordance with adjustment operation by the user for a slope and an intercept (bias) of the displayed straight line (adjustment operation by means of the operation unit 24). The control unit 21 then sets the weight coefficient for each pixel within the designated region of the radiation image based on the adjusted straight line. The control unit 21 multiplies the signal value of the designated region by the weight coefficient set in step S4, and multiplies the signal value of the outside of the designated region by the default weight coefficient. The control unit 21 thus generates the difference image using the above-mentioned (Formula 1).

In a case where the weight coefficient within the designated region is non-linearly changed, for example, the control unit 21 displays, on the display unit 25, a curve representing a relation between the signal value of the pixel (or the signal value difference between the pixels) and the weight coefficient as illustrated in FIG. 8. The control unit 21 then adjusts the weight coefficient for each pixel within the designated region in accordance with adjustment operation by the user for a shape and an intercept (bias) of the displayed curve (adjustment operation by means of the operation unit 24). For example, the shape of the curve can be adjusted in such a manner that the curve drawn in advance is magnified and reduced in vertical and horizontal directions in accordance with the operation for the operation unit 24. The intercept can be adjusted in such a manner that the curve drawn in advance is moved in upward and downward directions in accordance with the operation for the operation unit 24. Alternatively, the shape of the curve may be adjusted in such a manner that the user designates some points on a graph by means of the operation unit 24, whereby an approximate curve is drawn, and the approximate curve is magnified and reduced in the vertical and horizontal directions in accordance with the operation for the operation unit 24. The shape of the curve may be adjusted in such a manner that a plurality of templates of curves is displayed and then selected by the user by means of the operation for the operation unit 24. The control unit 21 then sets the weight coefficient for each pixel within the designated region of the radiation image based on the adjusted curve. The control unit 21 multiplies the signal value of the designated region by the weight coefficient set in step S4, and multiplies the signal value of the outside of the designated region by the default weight coefficient. The control unit 21 thus generates the difference image using the above-mentioned (Formula 1).

At the time of the adjustment of the weight coefficient, the difference image generated by using the weight coefficient is displayed on the display unit 25 in quasi real time, whereby the user can appropriately adjust the weight coefficient while understanding an effect of the change of the weight. The difference image to be displayed may have a size that is reduced as compared with an original display size, whereby a real time property may be improved.

The user can preferably select, by means of the operation for the operation unit 24, whether to set the weight coefficient that is uniform within the designated region, set the weight coefficient within the designated region so that the weight coefficient is linearly changed, or set the weight coefficient within the designated region so that the weight coefficient is non-linearly changed. In the same way as within the designated region, the weight coefficient that is different from the default may be enabled to be set for the region other than the designated region.

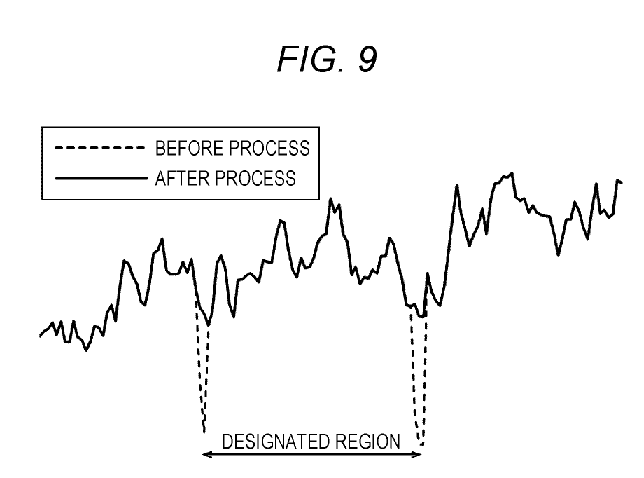

In a case where the weight coefficient within the designated region is adjusted as illustrated in a signal value profile before a process in FIG. 9, a level difference between the signal value of the designated region and the signal value of a peripheral region of the designated region occurs, and the image sometimes looks as if a structure existed. In this regard, in step S5, the control unit 21 also performs a process for aligning a baseline of the signal value of the designated region of the generated difference image with the region outside the designated region.

The difference image generated in the above-mentioned difference image generation process A is displayed on the display unit 25. The generated difference image is stored in the image DB 231 in association with the radiation image.

As described above, in the present embodiment, when the region in which the deterioration in the image quality caused by the influence of the beam hardening occurs is designated as the region for which the weight coefficient is to be corrected, the weight coefficient that is different from the default weight coefficient is set for the designated region of the radiation image, whereby the difference image is generated. Therefore, the weight coefficient can be adjusted only for the region in which the deterioration in the image quality caused by the influence of the beam hardening occurs while the region for which the most suitable weight coefficient is currently set remains unchanged. As a result, the difference process can be performed using the most suitable weight coefficient for the entire image, and the quality of the entire image can be improved.

### Second Embodiment

Next, a second embodiment of the present invention will be described.

Since configurations of the radiation image system 100 and each device constituting the radiation image system 100 according to the second embodiment are similar to those described in the first embodiment, the description is incorporated. Since operation of the radiation photographing device 1 is also similar to that described in the first embodiment, the description is incorporated. Hereinafter, operation of the medical image processing device 2 according to the second embodiment will be described.

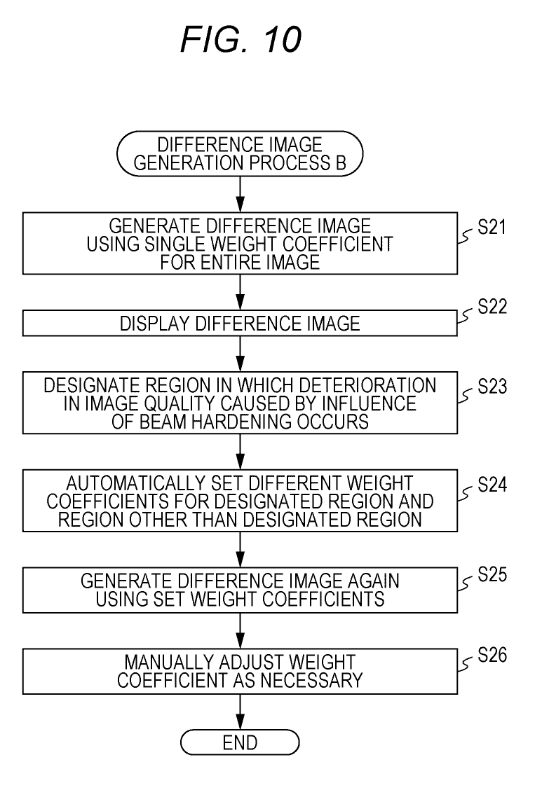

A flowchart of a difference image generation process B that is executed by the control unit 21 is illustrated in FIG. 10. The control unit 21 and the program stored in the storage unit 23 cooperate with each other, whereby the difference image generation process B is executed.

First, the control unit 21 generates a difference image using a single weight coefficient for the entire image (step S21). Since the process in step S21 is similar to the process in step S1 in FIG. 3, the description is incorporated.

Next, the control unit 21 causes the display unit 25 to display the generated difference image (step S22).

Next, the control unit 21 designates a region in which the deterioration in the image quality caused by the influence of the beam hardening occurs (step S23). Since the process in step S23 is similar to the process in step S3 in FIG. 3, the description is incorporated.

Next, the control unit 21 automatically sets different weight coefficients for the designated region of the radiation image and the region other than the designated region (step S24). The control unit 21 generates a difference image again using the set weight coefficients (step S25).

In step S24, the control unit 21 analyzes a signal value within the region for each of the designated region of the difference image and the region other than the designated region. The control unit 21 then sets the most suitable weight coefficient for each of the designated region of the radiation image and the region other than the designated region based on a feature of the analyzed signal value, and generates the difference image using the set weight coefficients. A process for aligning baselines of the signal values of the designated region and the region other than designated region value is also performed. The weight coefficient set for each region may be a fixed value, or may be linear or non-linear with respect to the signal value of the pixel or the signal value difference. The most suitable weight coefficient corresponding to the feature of the signal value is experimentally obtained in advance. The control unit 21 sets the most suitable weight coefficient corresponding to the feature obtained by analyzing the signal value of each region of the difference image.

The reason why the weight coefficient for the region outside the designated region is also set again is because the default weight coefficient might not be the most suitable weight coefficient depending on a figure of a patient, i.e., the object.

Next, the control unit 21 causes the display unit 25 to display the generated difference image and adjusts the weight coefficient for each region in accordance with the user operation for the operation unit 24 (step S26). Since the adjustment method in step S26 is similar to that described in step S4 in FIG. 3, the description is incorporated. When the adjustment of the weight coefficient is ended, the control unit 21 ends the difference image generation process B.

In the second embodiment, when the region in which the deterioration in the image quality caused by the influence of the beam hardening occurs is designated, the different weight coefficients are automatically set within the designated region and outside the designated region. The difference image is thus generated and displayed on the display unit 25. Then, the adjustment of the weight coefficient performed by the user is accepted. Therefore, the user only needs to check the difference image including the weight coefficient automatically adjusted for each of the designated region and the region other than the designated region, and to finely adjust the weight coefficient if necessary. Thus, time and effort for the user adjustment can be reduced.

### Third Embodiment

Next, a third embodiment of the present invention will be described.

Since configurations of the radiation image system 100 and each device constituting the radiation image system 100 according to the third embodiment are similar to those described in the first embodiment, the description is incorporated. Since operation of the radiation photographing device 1 is also similar to that described in the first embodiment, the description is incorporated. Hereinafter, operation of the medical image processing device 2 according to the third embodiment will be described.

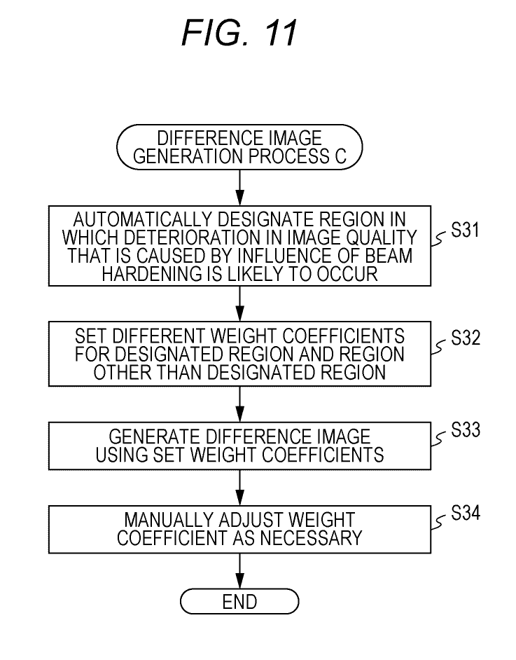

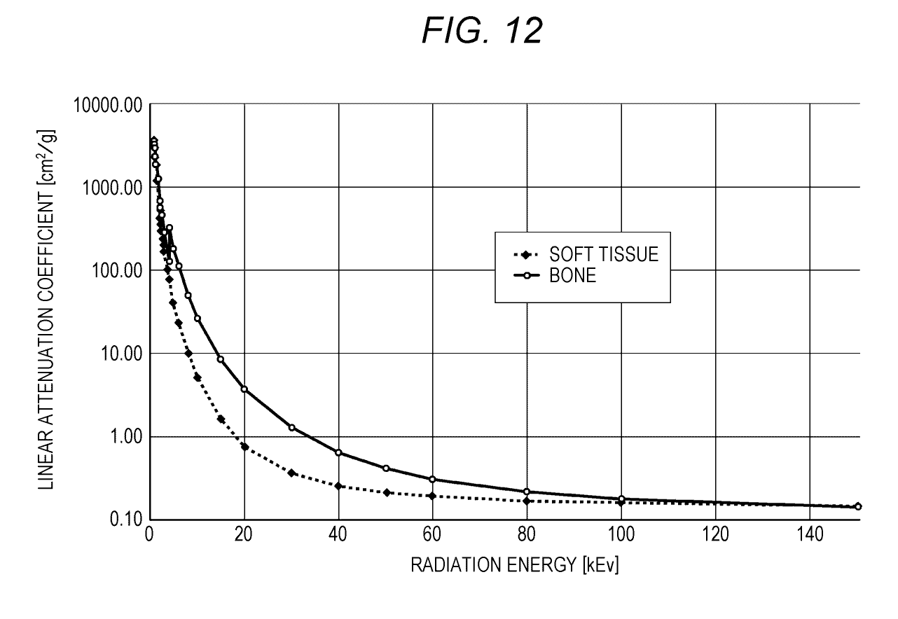

A flowchart of a difference image generation process C that is executed by the control unit 21 is illustrated in FIG. 11. The control unit 21 and the program stored in the storage unit 23 cooperate with each other, whereby the difference image generation process C is executed.

First, the control unit 21 automatically designates a region in which the deterioration in the image quality that is caused by the influence of the beam hardening is likely to occur (step S31).

For example, first, the control unit 21 multiplies the signal values of the corresponding pixels of the two radiation images, i.e., the high energy image and the low energy image, by the weight coefficient, and obtains a difference, thereby generating the difference image. Next, the control unit 21 automatically recognizes the region in which the deterioration in the image quality that is caused by the influence of the beam hardening is likely to occur based on the generated difference image, and designates the recognized region as the region for which the weight coefficient is to be corrected. Since the automatic recognition method is similar to that described in step S3 in FIG. 3, the description is incorporated.

When the designation of the region in which the deterioration in the image quality that is caused by the influence of the beam hardening is likely to occur is ended, the control unit 21 executes processes in steps S32 to S34 and ends the difference image generation process. Since the processes in steps S32 to S34 are similar to those described in steps S24 to S26 in FIG. 10, the description is incorporated.

In the third embodiment, the region in which the deterioration in the image quality that is caused by the influence of the beam hardening is likely to occur is automatically designated, and the different weight coefficients are automatically set within the designated region and outside the designated region. The difference image is thus generated and displayed on the display unit 25. Then, the adjustment of the weight coefficient performed by the user is accepted. Therefore, the user only needs to check the difference image generated by using the automatically adjusted weight coefficient, and to finely adjust the weight coefficient if necessary. Thus, time and effort for the user adjustment can be reduced.

As described above, according to the medical image processing device 2, the control unit 21 sets the different weight coefficients for the specific region and the region other than the specific region in the plurality of radiation images obtained in such a manner that the same object is irradiated with the beams of radiation having the different energy distributions at the different timings in the radiation photographing device 1. The control unit 21 then multiplies the signal values of the respective pixels of the radiation image by the set weight coefficients and performs the difference process to generate the difference image.

Therefore, since the weight coefficient that is appropriate for each region can be set for the specific region and the region other than the specific region, the quality of the entire image of the difference image can be improved as compared with a case where a single weight coefficient is set for the entire image.

For example, the control unit 21 causes the display unit 25 to display the difference image generated in such a manner that the signal values of all the pixels of the radiation image are multiplied by the single weight coefficient and subjected to the difference process. The control unit 21 then designates, as the above-mentioned specific region, the region designated by the user operation from the displayed difference image. Therefore, the user confirms the difference image generated by the multiplication of the single weight coefficient and the difference process, and designates, as the specific region, the region with an inappropriate weight coefficient such as, for example, the region in which the deterioration in the image quality caused by the influence of the beam hardening occurs. Consequently, the user can set, for the designated region, the weight coefficient that is different from the weight coefficient for the other region.

At this time, the region in which the deterioration in the image quality caused by the influence of the beam hardening is estimated to occur is presented by means of a frame border or the like so as to be clearly shown. As a result, the region to which the user should particularly pay attention is clarified, leading to a reduction in the number of confirmation steps. Furthermore, information (a weight coefficient value or a function of the weight coefficient) used in the arithmetic operation in the above-mentioned region is stored and used as a base point when the user manually adjusts the above-mentioned region, whereby the number of steps for the manual adjustment is expected to be reduced.

For example, the control unit 21 analyzes the signal value of the difference image generated in such a manner that the signal values of all the pixels of the radiation image are multiplied by the single weight coefficient and subjected to the difference process. The control unit 21 thus automatically designates the above-mentioned specific region. Therefore, it is possible to save time and effort for the user to manually designate the specific region for which the weight coefficient that is different from the other weight coefficient should be set.

For example, the control unit 21 recognizes the region in which the deterioration in the image quality caused by the influence of the beam hardening occurs in the difference image by analyzing the difference image generated in such a manner that the signal values of all the pixels of the radiation image are multiplied by the single weight coefficient and subjected to the difference process. The control unit 21 then designates the above-mentioned specific region based on the recognized region. Therefore, the weight coefficient that is different from the other weight coefficient can be set for the region in which the deterioration in the image quality caused by the influence of the beam hardening occurs in the difference image.

For example, the control unit 21 designates the above-mentioned specific region based on the information of the region in which the deterioration in the image quality caused by the influence of the beam hardening has occurred in the previously generated difference image, whereby the specific region can be designated with a fair degree of accuracy.

For example, the control unit 21 designates the above-mentioned specific region based on the information indicating the region in which the deterioration in the image quality that is caused by the influence of the beam hardening is likely to occur, whereby the specific region can be roughly designated.

For example, the control unit 21 sets the different weight coefficients for the above-mentioned specific region and the region other than the specific region in accordance with the user operation, whereby the difference image of good quality for the user can be generated.

For example, the control unit 21 analyzes each of the specific region and the region other than the specific region in the difference image generated in such a manner that the signal values of all the pixels of the radiation image are multiplied by the single weight coefficient and subjected to the difference process. The control unit 21 then sets the different weight coefficients for the specific region and the region other than the specific region based on the analysis result. Therefore, the difference image of good quality can be generated without time and effort of the user. Since the set weight coefficient can be adjusted by the operation for the operation unit 24, even if the set weight coefficient is not the most suitable weight coefficient, the fine adjustment can be performed to obtain the difference image of good quality.

The descriptions of the above-mentioned embodiments are only preferable examples according to the present invention and not limiting examples.

For example, in the above-mentioned embodiments, the difference image is generated in such a manner that each pixel of the high energy image is multiplied by the weight coefficient and subjected to the difference process. Alternatively, each pixel of the low energy image may also be multiplied by the weight coefficient.

For example, the above-mentioned embodiments have disclosed an example in which the HDD or the non-volatile memory is used as the computer-readable medium in which the program for executing each process is stored. However, the computer-readable medium is not limited to this example. A portable recording medium such as a CD-ROM can be applied as another computer-readable medium. A carrier wave may be applied as a medium for providing data of the program via a communication line.

Additionally, a detailed configuration and detailed operation of each device constituting the radiation image system can also be appropriately changed in a range not departing from the gist of the invention.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A medical image processing device comprising:
a difference image generation unit configured to multiply signal values of corresponding pixels of a plurality of radiation images by a predetermined weight coefficient and perform a difference process to generate a difference image, the plurality of radiation images being obtained in such a manner that the same object is irradiated with beams of radiation having different energy distributions at different timings; and
a setting unit configured to set different weight coefficients for a specific region of the radiation image and a region other than the specific region, wherein
the difference image generation unit generates the difference image using the weight coefficients set by the setting unit.

2. The medical image processing device according to claim 1, comprising a designating unit configured to designate the specific region based on a difference image generated in such a manner that signal values of all pixels of the radiation image are multiplied by a single weight coefficient and subjected to the difference process by the difference image generation unit.

3. The medical image processing device according to claim 2, comprising a display unit configured to display the difference image generated in such a manner that the signal values of all the pixels of the radiation image are multiplied by the single weight coefficient and subjected to the difference process by the difference image generation unit, wherein
the designating unit designates, as the specific region, a region designated by user operation from the difference image displayed by the display unit.

4. The medical image processing device according to claim 2, wherein
the designating unit designates the specific region by analyzing a signal value of the difference image generated in such a manner that the signal values of all the pixels of the radiation image are multiplied by the single weight coefficient and subjected to the difference process by the difference image generation unit.

5. The medical image processing device according to claim 4, wherein
the designating unit recognizes a region in which a deterioration in image quality caused by an influence of beam hardening occurs in the difference image by analyzing the difference image generated in such a manner that the signal values of all the pixels of the radiation image are multiplied by the single weight coefficient and subjected to the difference process by the difference image generation unit, and
the designating unit designates the specific region based on the recognized region.

6. The medical image processing device according to claim 2, wherein
the designating unit designates the specific region based on information of a region in which a deterioration in image quality caused by an influence of beam hardening has occurred in a previously generated difference image.

7. The medical image processing device according to claim 2, wherein
the designating unit designates the specific region based on information indicating a region in which a deterioration in image quality that is caused by an influence of beam hardening is likely to occur.

8. The medical image processing device according to claim 1, wherein
the setting unit sets the different weight coefficients for the specific region and the region other than the specific region in accordance with user operation.

9. The medical image processing device according to claim 1, wherein
the setting unit analyzes each of the specific region and the region other than the specific region in the difference image generated in such a manner that signal values of all pixels of the radiation image are multiplied by a single weight coefficient and subjected to the difference process by the difference image generation unit, and
the setting unit sets the different weight coefficients for the specific region and the region other than the specific region based on an analysis result.

10. The medical image processing device according to claim 9, comprising an adjustment unit configured to adjust the weight coefficient set by the setting unit.

11. A non-transitory recording medium storing a computer readable program for causing a computer to function as:
a setting unit configured to set different weight coefficients for a specific region and a region other than the specific region in a plurality of radiation images obtained in such a manner that the same object is irradiated with beams of radiation having different energy distributions at different timings; and
a difference image generation unit configured to multiply signal values of corresponding pixels of the plurality of radiation images by the set weight coefficients and perform a difference process to generate a difference image.
